(19) United States
(12) Patent Application Publication
(10) Pub. No.: US 2012/0196167 A1
(43) Pub. Date: Aug. 2, 2012

(54) ELECTRODE ASSEMBLY FOR A BATTERY AND METHOD FOR MANUFACTURING SAME

(75) Inventors: Joo Wan Kim, Asan-si (KR); Jong Hwan Kim, Daejeon (KR)

(73) Assignee: SK INNOVATION CO., LTD., Seoul (KR)

(21) Appl. No.: 13/500,714

(22) PCT Filed: Oct. 6, 2010
(86) PCT No.: PCT/KR2010/006826

§ 371 Date: Apr. 6, 2012

(30) Foreign Application Priority Data
Oct. 7, 2009 (KR) 10-2009-0095349

(51) Int. Cl. H01M 4/64; H01M 4/04; H01M 4/00

(52) U.S. Cl. 429/94; 429/149; 29/623.1

(57) ABSTRACT

The present invention provides an electrode assembly, which can be manufactured by alternately stacking cathode plates and anode plates while interposing a separator therebetween, and winding or folding the separator in one or both directions, and to a manufacturing method thereof. According to the invention, both sides or the lower sides of both edges of a cathode current collector is exposed to create a level difference between the edges and a cathode conductive layer, thereby forming a level-difference portion, and an adhesive is applied to the level-difference portion which is then adhered to a separator, whereby the thickness of the battery can be prevented from increasing due to the adhesive during the manufacture of the battery, and the assembly of the battery can be facilitated. Also, a level-difference portion may be formed at an anode current collector, thereby effectively preventing the thickness of the battery from being increased due to the build up of the adhesive. Thus, the performance of the battery can be prevented from being deteriorated due to the application of the adhesive, and the ability to be impregnated with an electrolytic solution can also be maintained intact.

### TECHNICAL FIELD

The present invention relates to an electrode assembly for batteries and a manufacturing method thereof, and more particularly to an electrode assembly for batteries, which can be manufactured by alternately stacking cathode plates and anode plates with a separator interposed therebetween, and winding or folding the separator in one or both directions, and to a manufacturing method thereof.

### BACKGROUND ART

In recent years, various types of portable electronic devices utilizing electrical energy have been developed and electric vehicles which are classified as environmentally friendly vehicles have received a lot of attention. The performance of batteries for storing and supplying electrical energy is related to the improvements in the performance of such portable electronic devices and electric vehicles and such batteries have become an important issue. Particularly, among batteries that are used in such devices, lithium secondary batteries have the advantages of a long cycle life and a high energy density per unit weight and have received attention.

Such lithium secondary batteries are classified depending on the type of electrolyte into lithium ion batteries employing liquid electrolytes and lithium polymer batteries employing polymer electrolytes. Among these, the lithium polymer batteries have the advantages of having a relatively high degree of stability, there being a lot of freedom in their shapes, and their having a structure in which a thin porous polymer separator is sandwiched between a cathode and an anode, each of which comprises an active material applied on a current collector. The separator is an insulating thin film having high mechanical strength and ion permeability and is configured to prevent an electronic short-circuit from forming between the cathode and the anode and to function as a channel for the intercalation and deintercalation of lithium ions. This separator may be made of polyethylene, polypropylene, a mixture thereof, or a non-woven fabric thereof.

Also, the current collectors for the cathode and the anode are made of highly conductive materials selected in consideration of their dissolution resulting from electrochemical side-reactions. Generally, the current collector for the cathode is made of aluminum, and the current collector for the anode is made of copper or the like. Active materials are applied onto the cathode and anode plates which were obtained by punching (or cutting) the current collector, and the cathode and anode plates to which the adhesive was applied are stacked on each other, thereby manufacturing a lithium secondary battery.

Namely, the lithium secondary battery generally comprises: an electrode assembly formed by stacking a cathode plate having a positive active material applied thereon, an anode plate having a negative active material applied thereon, and a separator positioned between the cathode plate and the anode plate on top of each other; a lithium secondary battery case receiving the electrode assembly; and an electrolyte placed in the lithium secondary battery case to allow the movement of lithium ions.

The electrode assembly for such lithium secondary batteries is manufactured by stacking the cathode and anode plates, punched (or cut) to a given size, on each other alternately in a zigzag fashion according to a desired capacity, while interposing the separator therebetween. Alternatively, the electrode assembly may be manufactured in a roll form by winding the cathode and anode plates, fabricated to have a length suitable for the design capacity, around a core while interposing the separator therebetween.

The electrode assembly thus manufactured is placed in the lithium secondary battery case so as not to be separated from the case, and the electrolyte is injected into the lithium secondary battery case, followed by the case being sealed, thereby manufacturing a lithium second battery.

However, in the method of manufacturing the electrode assembly by stacking the cathode and anode plates in a zigzag fashion, there is a problem in that, because the cathode and anode plates come into simple physical contact with each other, the cathode and anode plates change positions on the separator when being stacked, thereby adversely affecting the manufacture of the electrode assembly.

In an attempt to solve this problem, the electrode assembly is manufactured by applying an adhesive to the cathode and anode plates, which were previously punched (or cut) to a given size, and then attaching the cathode and anode plates to the separator, followed by folding the resulting structure, such that the cathode and anode plates do not change positions during the manufacture of the electrode assembly, thus facilitating the manufacture of the electrode assembly. However, in this case, there are problems in that the charge and discharge of electric current do not take place at the portion having the adhesive applied thereto, thus reducing the battery capacity, and also in that the adhesive portion builds up when the cathode plate and the anode plate are stacked which increases the thickness of the electrode assembly and the battery.

Meanwhile, there is another conventional method for manufacturing an electrode assembly for batteries, the method comprising coating the surface of a separator with a polymer, disposing cathode plates and anode plates on two sheets of the separator (hereinafter referred to as “a first separator and a second separator”) at a constant interval, subjecting the cathode and anode plates to a lamination process, attaching the cathode plates and the anode plates to the first separator and the second separator, respectively, and then winding the cathode plates together with the anode plates around a core.

In this method, the cathode plate and the anode plate are prevented from moving on the separators during the manufacture of the battery, such that the electrode assembly can be manufactured by winding, thereby improving the productivity of the battery. However, there is a problem in that the ability to be impregnated with an electrolytic solution and the performance of the battery are reduced because the polymer is used to coat on the separators.

### DISCLOSURE

### Technical Problem

The present invention has been made in order to solve the above-described problems occurring in the prior art, and it is an object of the present invention to provide an electrode assembly for batteries and a manufacturing method, in which both sides or the lower sides of both edges of a cathode current collector are exposed to create a level difference between the edges of the cathode current collector and a cathode conductive layer, thereby forming a level-difference portion, and an adhesive is applied to the level-difference portion which is then adhered to a separator, whereby the thickness of the battery can be prevented from being increased due to the adhesive during the manufacture of the battery, and the assembly of the battery can be facilitated.

### Technical Solution

To achieve the above object, the present invention provides an electrode assembly for batteries, including: a plurality of cathode plates 100 having a level-difference portion 111 formed to have a level difference with respect to a cathode conductive layer 120 by exposing a cathode current collector 110; a plurality of anode plates 200; a first separator 310 on which the plurality of the cathode plates 100 having an adhesive applied to the level-difference portion 111 are placed and fixed so as to be spaced apart from each other; and a second separator 320 on which a plurality of the anode plates 200 are placed and fixed so as to be spaced apart from each other,

wherein the first separator 310 and the second separator 320 are laid on each other and wound in one direction, whereby the anode plates 200 and the cathode plates 100 are alternately stacked on each other while interposing the separators 310 and 320 therebetween.

The present invention also provides a method for manufacturing an electrode assembly for batteries, including the steps of: providing cathode plates 100 having a level-difference portion 111 formed to have a level difference with respect to a cathode conductive layer 120 by exposing a portion of a cathode current collector 110; providing anode plates 200; placing and fixing a plurality of the cathode plates 100 apart from each other on a first separator 310; placing and fixing a plurality of the anode plates 200 on a second separator 320; and laying the first separator 310 and the second separator 320 on one another and winding the laid separators in one direction, thereby stacking the anode plates 200 and the cathode plates 100 in an alternating fashion, wherein an adhesive is applied to the level-difference portion 111 such that the thickness of the electrode assembly is not increased.

### ADVANTAGEOUS EFFECTS

According to the present invention, an adhesive is applied to the level-difference portion formed at the cathode current collector, and the level-difference portion is fixed on the separator, thereby making it possible to prevent the thickness of the battery from increasing because of the adhesive building up when the battery is being manufactured and to facilitate the manufacture of the electrode assembly.

Also, a level-difference portion may also be formed at the anode current collector, whereby it is possible to more effectively prevent the thickness of the battery from increasing due to the building up of the adhesive during the manufacture of the battery.

Thus, according to the present invention, the adhesive does not adversely affect the conductive layer portion in which the charge and discharge of the battery substantially occur, and thus it is possible to prevent the performance of the battery from deteriorating due to the application of the adhesive, to maintain the performance of the battery and to maintain the ability to be impregnated with an electrolytic solution intact.

In addition, according to the present invention, the electrode assembly can be manufactured using a winding process, whereby the manufacturing process thereof is simplified and the productivity of the product is increased.

### DESCRIPTION OF DRAWINGS

FIG. 1 is a perspective view showing an embodiment of a cathode plate according to the present invention.

FIGS. 2 to 7 illustrate embodiments of various combinations of a cathode plate and an anode plate according to the present invention.

FIGS. 8 to 10 are perspective views showing a process of manufacturing an electrode assembly in a roll form according to the present invention.

FIG. 11 is a perspective view showing an electrode assembly manufactured by folding a separator in a zigzag fashion according to the present invention.

### DESCRIPTION OF MAIN REFERENCE NUMERALS USED IN THE DRAWINGS

100: cathode plate; 110: cathode current collector; 111: level-difference portion of cathode plate; 111a: upper-side level-difference portion of cathode plate; 111b: lower-side level-difference portion of cathode plate; 120: cathode conductive layer; 200: anode plate; 210: anode current collector; 211: level-difference portion of anode plate; 211a: upper-side level-difference portion of anode plate; 211b: lower-side level-difference portion of anode plate; 220: anode conductive plate; 310: first separator; 320: second separator; 330: separator; and 400: a fixing member.

### BEST MODE

Terms used in the present invention are used to illustrate the exemplary embodiments, but are not intended to limit the scope of present invention. A singular expression includes a plural expression except that two expressions are contextually different from each other. The present invention may include several embodiments, and a repeated description of the same components as those of the prior art will be omitted.

Hereinafter, the present invention will be described in detail with reference to the preferred embodiments.

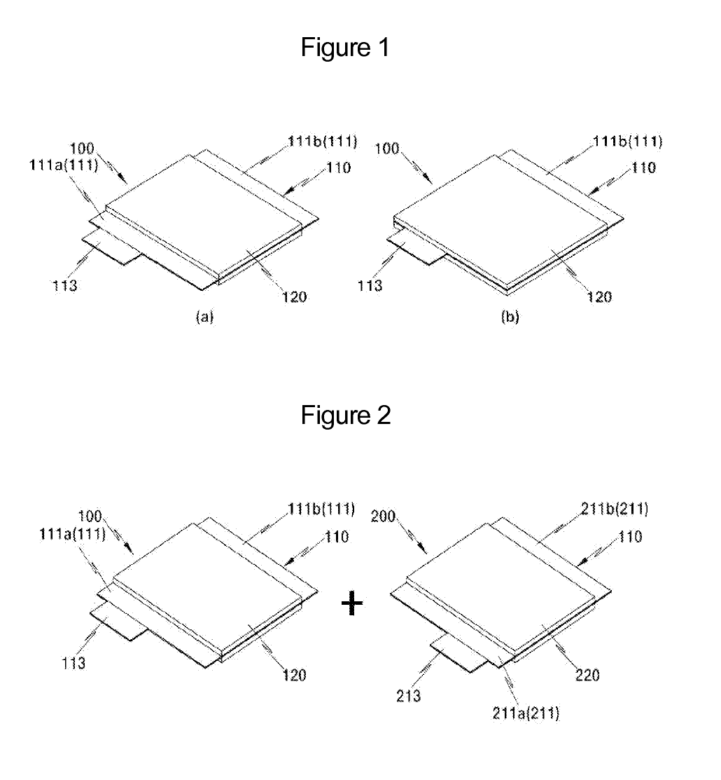

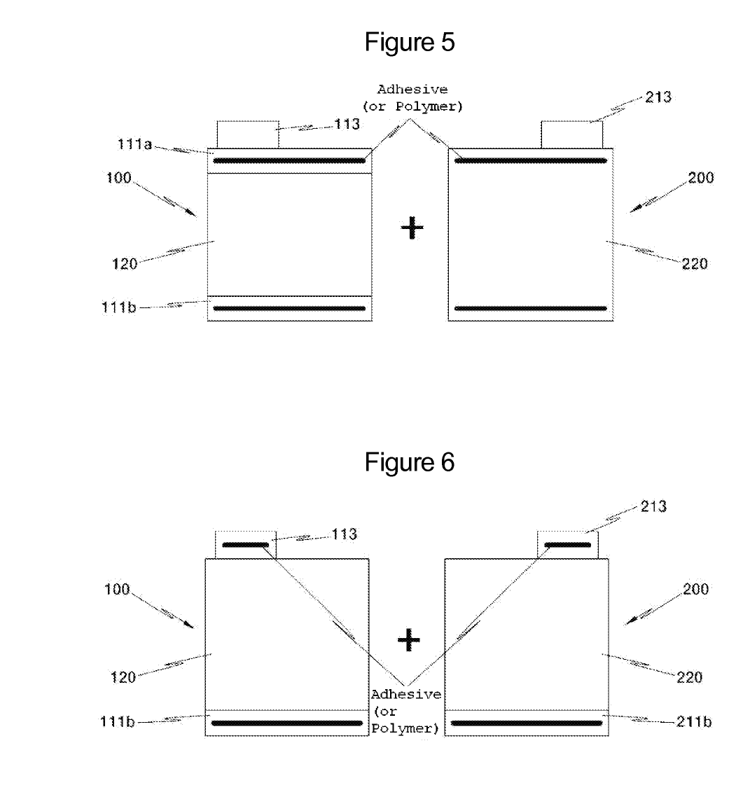

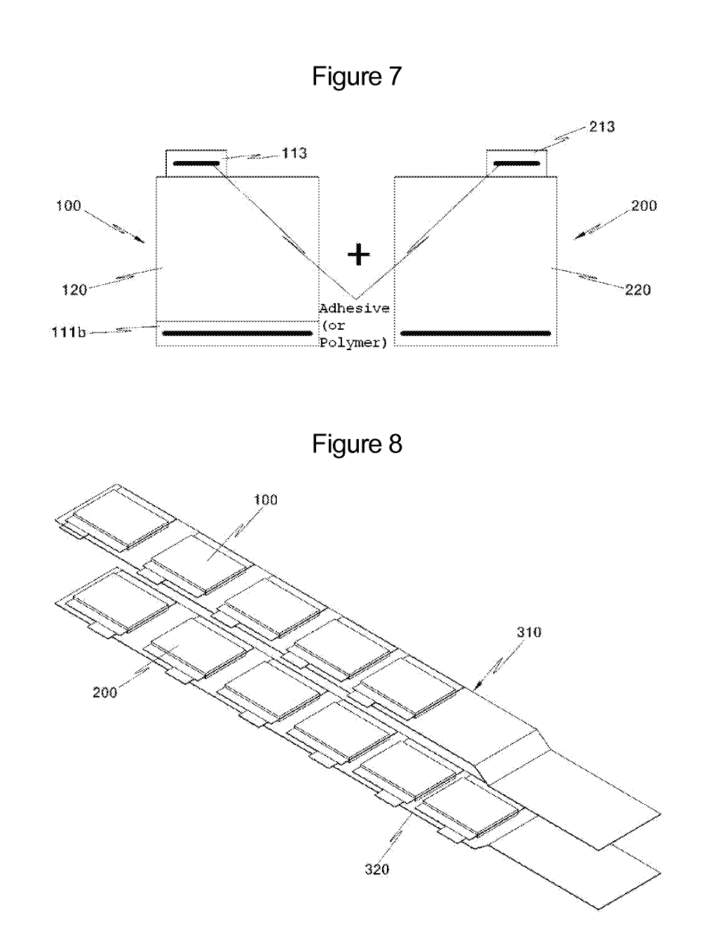

FIG. 1 is a perspective view showing an embodiment of a cathode plate according to the present invention, and FIGS. 2 to 7 illustrate embodiments of various combinations of a cathode plate and an anode plate according to the present invention.

As shown therein, the present invention relates to an electrode assembly for batteries and a manufacturing method thereof, in which cathode plates 100 and anode plates 200 are alternately stacked on each other while interposing separators 310, 320 and 330 therebetween. More specifically, the present invention provides an electrode assembly for batteries and a manufacturing method thereof, in which an adhesive (or polymer) is applied to the electrode plates 100 and 200 which are then fixed to separators 310, 320 and 330, and the separators 310, 320 and 330 are wound in one direction or both directions, whereby the battery can be manufactured using a stacking process without the adhesive increasing the thickness of the battery.

For this purpose, according to the present invention, as shown in FIG. 1, a portion of the cathode current collector 110 of the cathode plate 100, to which an adhesive is to be applied, is exposed to form a level-difference portion 111 of the cathode plate, and an adhesive is applied to the level-difference portion 111 which is then fixed to a separator 310 (first separator), whereby a battery can be manufactured using a winding process, like a conventional small-sized battery. More specifically, the cathode plate 100 comprises: a cathode current collector 110 having a cathode tab junction 113; and cathode conductive layers 120 deposited on both sides of the cathode current collector 110. As shown in FIG. 1(a), both the upper and lower sides of both edges of the cathode current plate 110 are exposed to form the level-difference portion 111 of the cathode plate, thereby providing a step difference between the cathode current plate 110 and the cathode conductive layer 120.

Then, an adhesive is applied to the level-difference portion 111 of the cathode plate, that is, to an upper-side level-difference portion 111a and a lower-side level-difference portion 111b, and the cathode plates 111 applied with the adhesive are attached and fixed on the first separator 310 at constant intervals. Alternatively, as shown in FIG. 1(b), only the lower sides of both edges of the cathode current collector 110 are exposed to form the lower-side level-difference portion 111b, and then an adhesive is applied to the lower-side level-difference portion 111b and the cathode tab junction 113, after which the adhesive side (portion applied with the adhesive) of the cathode plate 100 is brought into contact with the first separator 310, whereby the cathode plates 100 can be attached and fixed to the first separator 310 at constant intervals.

The conductive layers 120 and 220 of the electrode plates 100 and 200 are portions in which charges are charged and discharged, and among them, if the cathode conductive layer 120 is stained with impurities such as an adhesive, the performance of the battery may deteriorate due to the influence of the impurities. For this reason, an adhesive is applied to the level-difference portion 111 of the cathode plate and or to the cathode tab junction 113, whereby the assembly of the battery can be improved without deteriorating the performance of the battery.

In addition, an adhesive is applied to portions having a step difference from the cathode conductive layer 120, that is, to the level-difference portion 111 and the cathode tab junction 113, whereby the adhesive can be prevented from increasing the thickness of the battery when the battery is being manufactured.

Meanwhile, the anode plates 200 in the electrode assembly for batteries are stacked alternately with the cathode plates 100 while interposing the separators 310 and 320 therebetween such that the anode plate and the cathode plate are paired. In the present invention, the anode plates 200 are also applied with an adhesive and placed on the second separator 320.

In the case of the anode plates in the electrode assembly, because interference by impurities such as the adhesive does not occur, the anode plates may be fixed to the separator 320 by applying the adhesive to the anode conductive layer 220 without forming the level-difference portion 211 of the anode plate. The thickness of the adhesive applied to the anode conductive plate 220 can be offset by the level-difference portion 111 of the cathode plate.

However, as FIG. 2 or 6, the level-difference portion 211 of the anode plate may also be formed at the anode current collector 210, whereby the thickness of the battery can be more effectively prevented from being increased due to the build up of the adhesive during the manufacture of the battery.

For this purpose, as shown in FIG. 2, a portion of the anode current collector 210, to which an adhesive is to be applied, is exposed to form a level-difference portion 211 of the anode plate, that is, an upper-side level-difference 211a of the anode plate and a lower-side level-difference portion 211b of the anode plate, and an adhesive is applied to the level-difference portion 211 of the anode plate, and then the anode plates are adhered and fixed to the second separator 320 at constant intervals.

Alternatively, as shown in FIG. 6, the anode plates may also be fixed to the second separator 320 without increasing the battery thickness due to an adhesive by forming only the lower-side level-difference portion 211b at the lower sides of both sides of the anode current collector 210 and then applying an adhesive to the level-difference portion 211b of the anode plate and to the anode tab junction 213.

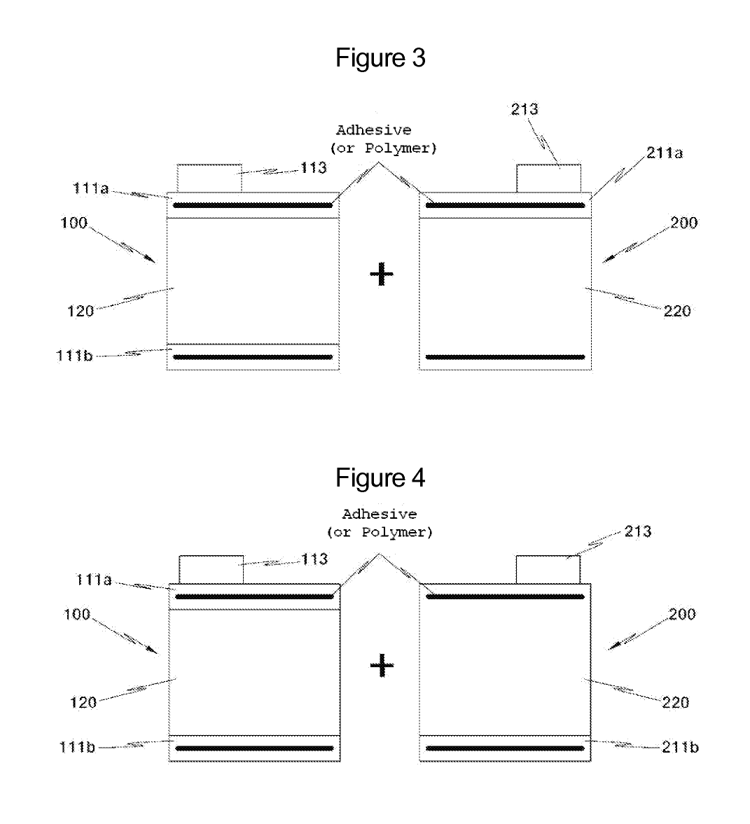

In addition, according to the present invention, as shown in FIGS. 3 to 5 and 7, various types of electrode assemblies may be manufactured by exposing one or both of the upper and lower surfaces of both edges of the anode current collector 210 to form an upper-side level-difference portion 211a and/or a lower-side level-difference portion 211b of the anode plate, and combining the cathode plates 100 and the anode plates 200, embodied in various ways, such that the cathode plate 100 and the anode plate 200 form a pair.

Meanwhile, in the present invention, the first separator 310 and the second separator 320 have a length such that a plurality of the electrode plates 100 and 200 can be disposed according to the design capacity of the battery.

As shown in FIGS. 2 to 7, according to the present invention, the cathode plates 100 and the anode plates 200 can be formed in various configurations depending on the position and number of the level-difference portions 111 and 211 of the electrode plates, and can be formed in such a way that the position of the level-difference portion 111 of the cathode plate corresponding to the position of the level-difference portion 211 of the anode plate more effectively prevents the thickness of the battery from increasing.

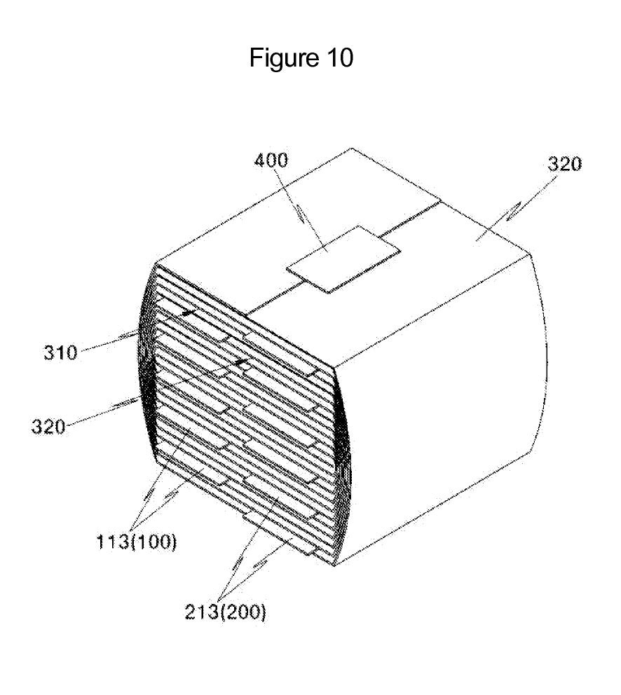

FIGS. 8 to 10 are perspective views showing a process of manufacturing an electrode assembly in a roll form according to the present invention.

As described above, according to the present invention, the cathode plates 100 and the anode plates 200 are disposed on the separators 310 and 320, respectively. Thus, as shown in FIGS. 8 to 10, the first separator 310 and the second separator 320 may be laid parallel to each other and folded together to form a roll shape.

Specifically, as shown in FIGS. 8 to 10, the first separator 310 having a plurality of cathode plates 100 disposed thereon is laid on the second separator 320 having a plurality of anode plates disposed thereon (the separators are laid on each other such that the cathode plate 100 and the anode plate 200 form a pair). Then, the two separators 310 and 320 are wound together around a core “C” in one direction, whereby the cathode plates 100 and the anode plates 200 are stacked on each other while interposing the separators 310 and 320 therebetween.

Also, after the stacking process, the outermost end of the second separator 320 is fixed to one side of the second separator 320 by means of a fixing member 400 such as polypropylene tape.

Herein, the interval between the cathode plates 100 or the anode plates 200 on each of the separators 310 and 320 preferably gradually increases in the direction in which the separators 310 and 320 are wound, in view of the fact that the battery thickness increases as the separators 310 and 320 are wound.

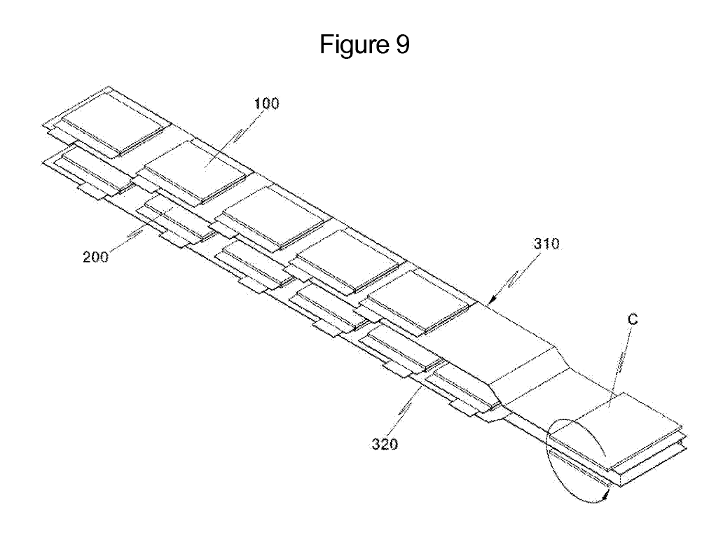

Furthermore, in order to allow the anode plates 200 to surround both sides of the cathode plates 100 in the initial winding state during the winding process, as shown in FIG. 9, the anode plates 200 of the second separator 320 are disposed ahead of the cathode plates of the first separator by one plate. Accordingly, the cathode plates 100 are disposed behind the anode plates 200 by one plate.

After the stacking of the electrodes 100 and 200 and the separators 310 and 320 has been performed as described above, the core “C” may be removed, thereby manufacturing an electrode assembly.

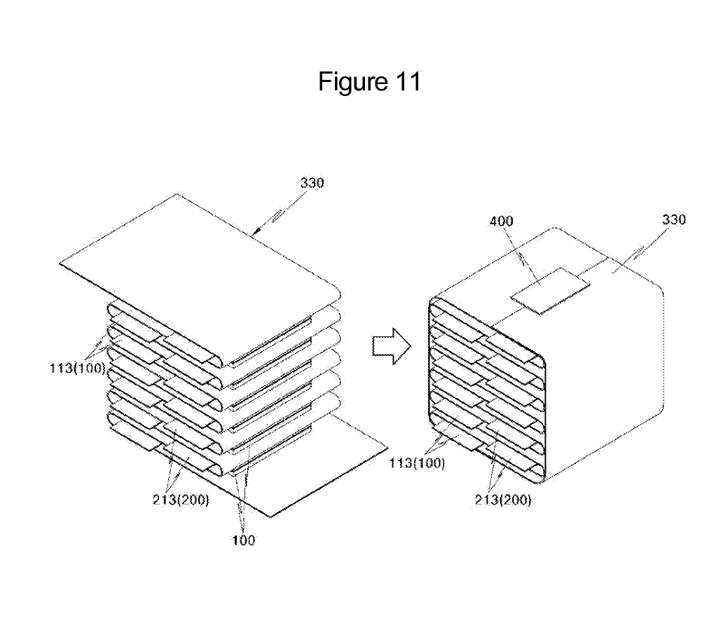

Meanwhile, FIG. 11 is a perspective view showing an electrode assembly manufactured by folding a separator 330 in a zigzag pattern according to the present invention.

The electrode assembly according to the present invention can also be manufactured using the cathode plate 100 and the anode plate 200 configured as described above, by folding one sheet of separator 330 in a zigzag fashion into a plurality of layers.

The embodiment shown in FIG. 11 will now be described in detail. The cathode plate 100 comprising the cathode plate level-difference portion 111 having the adhesive applied thereto is placed on the separator 330, and then the separator 330 is folded in one direction so as to surround the cathode plate 100, after which the anode plate 200 comprising the anode plate level-difference portion 211 having the adhesive applied thereto is placed on the separator 330 such that it is placed above the cathode plate 100.

Then, the separator 330 is folded in the other direction so as to surround the anode 200, after which another cathode 100 having the adhesive applied thereto is placed such that it is placed above the anode plate 200.

The folding process may be repeated depending on the design capacity of a battery to be manufactured, thereby manufacturing a multilayer electrode assembly in which the cathode plates 100 and the anode plates 200 are alternately stacked on each other while the separator 330 is interposed therebetween.

Herein, both ends of the separator 330 that has been folded in a zigzag fashion while surrounding the electrode plates are wound such that they surround the edges of the electrode plates 100 and 200 exposed through the separator 330 folded in both directions. Then, both ends of the separator 330 are fixed to one side of the separator 330 by means of a fixing member 400 such as polypropylene tape.

In the present invention, although an adhesive is applied to a portion of the anode conductive layer 220, impurities (adhesive) does not interfere with the anode plate 200, and the portion of the anode conductive layer 220 to which the adhesive was applied is a portion corresponding to the position of the cathode plate level-difference portion 111 during the manufacture of the electrode assembly. Accordingly, in this portion, charge and discharge are not substantially performed, and thus the ability of the battery to be impregnated with an electrolytic solution which is injected into the battery case can be maintained intact without deteriorating.

Meanwhile, in another embodiment of the present invention, an electrode assembly may also be manufactured in such a manner that the cathode tab junction 113 and the anode tab junction 213 face different directions.

As described above, the electrode assembly for batteries can be manufactured using a winding process by fixing the cathode plates 100 and the anode plates 200 on the separators 310 and 320 by means of adhesive, whereby the manufacturing process of batteries can be simplified and the productivity of the batteries can be improved.

Moreover, in the conductive layers 120 and 220, particularly the cathode conductive layer 120, in which charge and discharge are substantially performed, interference by the adhesive does not occur. Thus, the performance and stability of the battery can be sufficiently ensured.

In addition, even when the electrode assembly is manufactured by folding the separator in a zigzag fashion according to the present invention, the cathode plates 100 and the anode plates 200 do not change positions on the separator 300, whereby the manufacturing process of the battery can be simplified to improve the productivity thereof.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. An electrode assembly for batteries, comprising:
a plurality of cathode plates having a level-difference portion formed to have a level difference with respect to a cathode conductive layer by exposing a cathode current collector;
a plurality of anode plates;
a first separator on which the plurality of the cathode plates having an adhesive applied to the level-difference portion are placed and fixed apart from each other; and
a second separator on which the plurality of the anode plates are placed and fixed apart from each other,
wherein the first separator and the second separator are laid on each other and wound in one direction, whereby the anode plates and the cathode plates are alternately stacked on each other while interposing the separators and therebetween.

2. An electrode assembly for batteries, comprising:
a separator folded in opposite directions to form a plurality of layers;
anode plates; and
cathode plates having a level-difference portion formed to have a level difference with respect to a cathode conductive layer by exposing a cathode current collector,
wherein the anode plates and the cathode plates are fixed to the separator and alternately stacked on each other while interposing the separator therebetween, and an adhesive is applied to the level-difference portion of the cathode plates such that it does not increase the thickness of the electrode assembly.

3. The electrode assembly of claim 1, wherein the level-difference portion of the cathode plates is formed at the lower sides of both edges of the cathode current collector.

4. The electrode assembly of claim 1, wherein the level-difference portion of the cathode plates is formed at both the upper and lower sides of both edges of the cathode current collector.

5. The electrode assembly of claim 1, wherein the anode plates have a level-difference portion formed to have a level difference with respect to an anode conductive layer by exposing an anode current collector, and an adhesive is applied to the level-difference portion of the anode plates.

6. The electrode assembly of claim 5, wherein the level-difference portion of the anode plates is formed at one or both of the upper and lower ends of the anode current collector.

7. The electrode assembly of claim 1, wherein the interval between the cathode plates or anode plates placed on a first separator or a second separator gradually increases in a direction in which the first separator or the second separator is wound.

8. A method for manufacturing an electrode assembly for batteries, comprising the steps of:
providing cathode plates having a level-difference portion formed to have a level difference with respect to a cathode conductive layer by exposing a portion of a cathode current collector;
providing anode plates; placing and fixing a plurality of the cathode plates apart from each other on a first separator;
placing and fixing a plurality of the anode plates on a second separator; and
laying the first separator and the second separator on one another and winding the laid separators in one direction, thereby stacking the anode plates and the cathode plates in an alternating fashion, wherein an adhesive is applied to the level-difference portion such that it does not increase the thickness of the electrode assembly.

9. A method for manufacturing an electrode assembly for batteries, comprising the steps of:
providing a separator;
providing anode plates;
providing cathode plates having a level-difference portion formed to have a level difference with respect to a cathode conductive layer by exposing a portion of a cathode current collector; and
placing the anode plates and the cathode plates on the separator while folding the separator in opposite directions to form a plurality of layers, in such a manner that the anode plates and the cathode plates are alternately stacked on each other while interposing the separator therebetween,
wherein an adhesive is applied to the level-difference portion of the cathode plates such that it does not increase the thickness of the electrode assembly.

10. The method of claim 8, wherein the level-difference portion of the cathode plates is formed at the lower sides of both edges of a cathode current collector.

11. The method of claim 8, wherein the level-difference portion of the cathode plates is formed at both the upper and lower sides of both edges of a cathode current collector.

12. The method of claim 8, the anode plates having a level-difference portion formed to have a level difference with respect to an anode conductive layer by exposing an anode current collector, and an adhesive is applied to the level-difference portion of the anode plates.

13. The method of claim 12, wherein the level-difference portion of the anode plates is formed at one or both of the upper and lower sides of both edges of the anode current collector.

14. The method of claim 8, wherein the interval between the cathode plates or anode plates placed on a first separator or a second separator gradually increases in a direction in which the first separator or the second separator is wound.

15. The electrode assembly of claim 2, wherein the level-difference portion of the cathode plates is formed at the lower sides of both edges of the cathode current collector.

16. The electrode assembly of claim 2, wherein the level-difference portion of the cathode plates is formed at both the upper and lower sides of both edges of the cathode current collector.

17. The electrode assembly of claim 2, wherein the anode plates have a level-difference portion formed to have a level difference with respect to an anode conductive layer by exposing an anode current collector, and an adhesive is applied to the level-difference portion of the anode plates.

18. The electrode assembly of claim 17, wherein the level-difference portion of the anode plates is formed at one or both of the upper and lower ends of the anode current collector.

19. The method of claim 9, wherein the level-difference portion of the cathode plates is formed at the lower sides of both edges of a cathode current collector.

20. The method of claim 9, wherein the level-difference portion of the cathode plates is formed at both the upper and lower sides of both edges of a cathode current collector.

21. The method of claim 9, the anode plates having a level-difference portion formed to have a level difference with respect to an anode conductive layer by exposing an anode current collector, and an adhesive is applied to the level-difference portion of the anode plates.

22. The method of claim 21, wherein the level-difference portion of the anode plates is formed at one or both of the upper and lower sides of both edges of the anode current collector.
